(19) United States
(12) Patent Application Publication
(10) Pub. No.: US 2018/0218368 A1
(43) Pub. Date: Aug. 2, 2018

(54) DATA TRANSFORMATION ENGINE

(71) Applicant: First Data Corporation, Greenwood Village, CO (US)

(72) Inventors: Pramod Rao, Alpharetta, GA (US); Christine Collins, Georgetown, TX (US); Eric Lefebvre, Marietta, GA (US); Padmini Sampathkumarachar, Duluth, GA (US); Nutan Sarkale, Cumming, GA (US)

(73) Assignee: First Data Corporation, Greenwood Village, CO (US)

(21) Appl. No.: 15/421,002

(22) Filed: Jan. 31, 2017

(51) Int. Cl. G06Q 20/40; H04L 29/08

(52) U.S. Cl. CPC G06Q 20/4014; H04L 12/66; H04L 67/10

(57) ABSTRACT

A method for transforming and routing data includes receiving data from one of a number of remote computing systems. The data is in the form of a first data format associated with a legacy processing system. Source information related to the one of the plurality of remote computing systems is identified. A determination is made that the one of the plurality of remote computing systems has been migrated to a new processing system based at least in part on the source information. The data is mapped to a second data format associated with the new processing system. A transmission is routed to the new processing system. The transmission includes the mapped data in the form of the second data format.

### BACKGROUND OF THE INVENTION

As computer technology evolves, users often update processing systems or other computing systems to meet the needs of the new technology. This typically requires that operating systems, application programming interfaces (API), and other software systems of devices that interface with the updated processing system must also be updated. Such updates typically require significant amounts of software coding to enable the various devices to continue communicating with one another. Additionally, it may not be feasible to update all of the devices that interface with the updated processing systems at a single time. This may be due to the various system architectures and APIs of the various devices, the quantity of devices, and/or the various needs and resources required to update the different devices. As a result, only those computing devices that have been updated for use with the updated processing system will be usable with the new processing system, while those computing devices that have not yet been updated may be unsupported, thus rendered ineffective.

### BRIEF SUMMARY OF THE INVENTION

The present invention is directed to systems and methods that use a gateway router system during migration of computing devices from legacy processing systems to new or updated processing systems. The gateway router systems are smart routers that route traffic from one platform to another. The gateway router systems described herein utilize service oriented architecture (SOA) in which components within the gateway router system, such as a distributed cache, are available as micro services. In some embodiments, gateway router systems may support Representational State Transfer (REST) http(s) protocol with embedded extensible markup language (XML) or JavaScript Object Notation (JSON) message payloads. The gateway router systems may include a data transformation engine (DTE) that works to convert or otherwise transform data from one format to another. The DTE described herein may be a high performance API transformer that can transform API specifications across different formats using external mapping files. The use of such DTEs enable smart router systems to route API traffic from one platform to another, as well as to transform API specifications from one format to another with little to no coding effort.

In one embodiment, a method for transforming and routing data is provided. The method may include receiving data from one of a plurality of remote computing systems. The data may be in the form of a first data format associated with a legacy processing system. The method may also include identifying source information related to the one of the plurality of remote computing systems and determining that the one of the plurality of remote computing systems has been migrated to a new processing system based at least in part on the source information. The method may further include mapping the data a second data format associated with the new processing system and routing a transmission to the new processing system. The transmission may include the mapped data in the form of the second data format.

In another embodiment, a gateway router system for transforming and routing data is provided. The gateway router system may include a gateway router interface. The gateway router interface may be configured to receive data from one of a plurality of remote computing systems. The data may be in the form of a first data format associated with a legacy processing system. The gateway router system may also be configured to identify source information related to the one of the plurality of remote computing systems and to determine whether the one of the plurality of remote computing systems has been migrated to a new processing system based at least in part on the source information. The gateway router interface may be further configured to route the data based on the determination. The gateway router system may also include a legacy system interface configured to receive the data from the gateway router interface when it is determined that the one of the plurality of remote computing systems has not been migrated to the new processing system and to transmit the data to a legacy processing system. The gateway router system may further include a data transformation engine. The data transformation engine may be configured to receive the data from the gateway router interface when it is determined that the one of the plurality of remote computing systems has been migrated to the new processing system. The data transformation engine may also be configured to map the data to a second data format associated with the new processing system. The gateway router system may include a new processing system interface configured to receive the mapped data from the data transformation engine and to route a transmission to the new processing system. The transmission may include the mapped data in the form of the second data format.

In another embodiment, a gateway router system for transforming and routing data may include at least one communications interface configured to communicate with one or more computing systems using at least one network. The gateway router system may also include a memory and at least one processing unit. The processing unit may be configured to receive, via the at least one communications interface, data from one of a plurality of remote computing systems. The data may be in the form of a first data protocol associated with a legacy processing system. The processing unit may also be configured to identify source information related to the one of the plurality of remote computing systems and to determine whether the one of the plurality of remote computing systems has been migrated to a new processing system based at least in part on the source information. The processing unit may be further configured to route the data to a legacy processing system when it is determined that the one of the plurality of remote computing systems has not been migrated to the new processing system and to map the data to a second data protocol associated with the new processing system when it is determined that the one of the plurality of remote computing systems has been migrated to the new processing system. The processing unit may also be configured to route a transmission to the new processing system. The transmission may include the mapped data in the form of the second data protocol.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a system diagram depicting the functionality of a gateway router system according to embodiments.

FIG. 2 is a system diagram depicting the functionality of a gateway router system in a payment processing application according to embodiments.

FIG. 3 is a flowchart depicting a process for routing and transforming data during a processing system migration according to embodiments.

FIG. 4 is a block diagram of a computing system according to embodiments.

### DETAILED DESCRIPTION OF THE INVENTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

The present invention is directed to systems and methods that use smart gateway router systems and data transformation engines to seamlessly transform API traffic using external mapping files and to route API traffic from one platform to another. This is particularly useful when a host's legacy gateways or processing systems begin to be phased out in favor of new or updated processing systems. In such situations, the computing devices that interact with the legacy processing system are gradually transitioned to the new processing system. The gateway router systems described herein enable the host or operator of the legacy processing system to continue supporting existing devices while making this transition, without the need to recode any of the connected devices.

Such gateway router systems and data transformation engines may be particularly useful in payment networks. For example, a financial institution or other payment facilitation entity may initiate a transition from a legacy payment processing network to a new payment processing network while still supporting existing merchants using the legacy payment processing system API specifications. The systems and methods described herein also provide a path for merchants to migrate to next generation payment processing systems or platforms. The gateway router systems described herein provide a technical solution that can be used not only for legacy payment processing systems, but any future platform consolidations as well. API traffic from merchants may be routed from one platform to another, and where needed, API specifications may be transformed from one format to another with no coding effort. While sometimes discussed in relation to payment processing networks, it will be appreciated that the gateway router systems described herein may be utilized in any other applications where one or more devices are being gradually transitioned from one processing system to another processing system that is compatible with different data formats and/or API specifications.

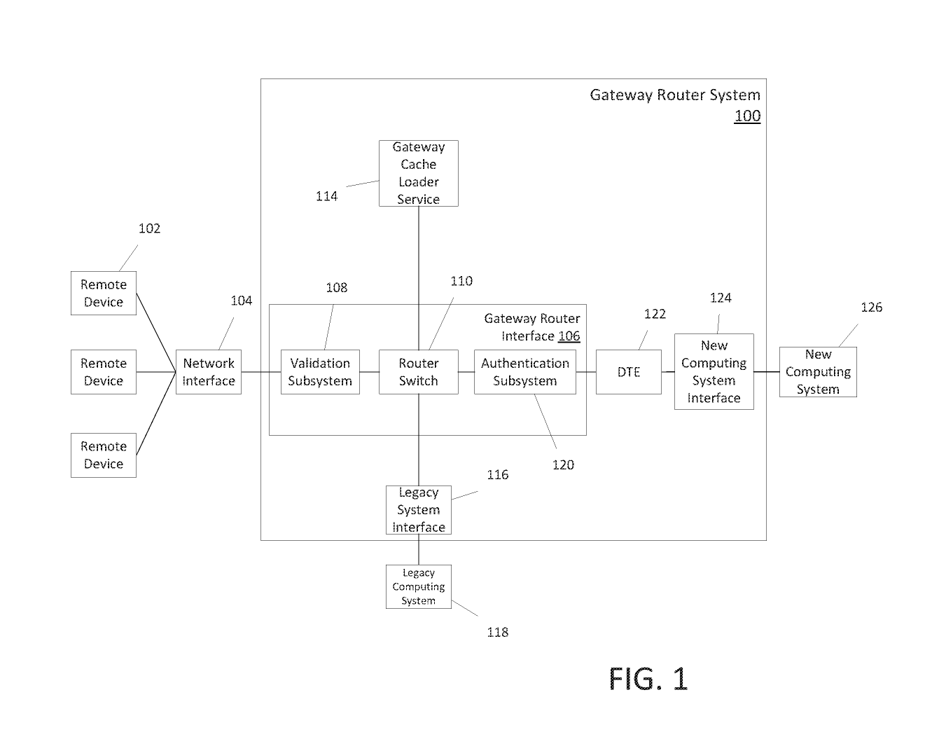

Turning now to FIG. 1, a system diagram of a gateway router system 100 for transforming and routing data is shown. Gateway router system 100 is often used when a host or other entity is migrating interactions with clients or other devices from a legacy processing system 118 that uses a first data format and/or data protocol to a new processing system 126 that uses a different second data format and/or protocol. For example, each processing system 118, 126 may be configured to interface with other devices and computing systems using different APIs. Such API differences be due to a number of factors, such as data needs, efficiency, and the like. The gateway router system 100 acts as a web service that accepts secure external traffic and/or payloads and transforms the payload. Here, one or more remote devices 102 or other computer systems may communicate with an integration network platform 104 that is communicatively coupled with the gateway router system 100. The remote devices 102 may be mobile devices, computer systems, servers, and/or other computing devices that are configured to interface with the gateway router system 100 using an API. In some embodiments, the remote devices 102 may be in direct communication with the gateway router system 100 rather than using an intermediate integration network platform 104.

Data may be received by the gateway router system 100 from the remote devices 102. In some embodiments, the data is received from the remote device 102 in an initial data format or data protocol, such as a format implementing specifications associated with a particular API. In other embodiments, the data may be converted or transformed into the initial data format or protocol by the integration network platform 104. As just one example, the remote devices 102 may send XML, data. In some embodiments, the integration network platform 104 may then convert the XML data into plain old Java object (POJO) data prior to communicating the data to the gateway router system 100.

The gateway router system 100 may include a gateway router interface 106 that receives the data from the remote devices 102 and/or the integration network platform 104. The gateway router interface 106 may include a validation subsystem 108 that is configured to validate the data received from the remote devices 102. For example, this may involve validating a payload format and/or customer credentials. Once validated, a router switch 110 may parse out a client identifier from the data and pass the client identifier to a gateway cache loader service 114. For example, details related to the source of the data (i.e. one of the remote devices 102) may be fetched from the gateway cache loader service 114. The details may include information indicative of whether the particular remote device 102 or other data source has been migrated to the new processing system 126, or if the remote device 102 is still being serviced by the legacy processing system 118. In some embodiments, such as if the gateway cache loader service 114 is empty and/or returns no details related to the particular source (or in embodiments not utilizing a gateway cache loader service 114), the details related to the particular source may be retrieved from a separate database (not shown). In some embodiments, the details may explicitly indicate whether migration has occurred, while in other embodiments the details may include only an identifier of the data source. In such embodiments, once the details are retrieved the router switch 110 may determine whether the remote device 102 has been migrated based on a comparison of the source identifier to a list of identifiers of migrated remote devices 102 to determine whether the particular remote device 102 has been migrated to the new processing system 126.

If the remote device 102 has not been migrated, the data is communicated to the legacy processing system 118 via a legacy system interface 116 of the gateway router system 100. In some embodiments, the legacy system interface 116 may convert the data back into its original form. For instance, the POJO data generated by the integration network platform 104 may be converted back into XML, data for use with the legacy processing system 118. The data may then be processed by the legacy processing system 118. In some embodiments, response data may be generated by or received at the legacy processing system 118. The response data may be communicated to the router switch 110 via the legacy system interface 116. The router switch 110 may then determine a destination of the response data, such as by retrieving details associated with the remote device 102 of the original data. For example, the response data may include an identifier or indication associating the response data with the original incoming data. The response data may then be routed to the proper destination/remote device 102 by the router switch 110. In embodiments that utilize a integration network platform 104, the integration network platform 104 may convert or otherwise transform the response data to the proper format for the particular remote device 102. For example, the integration network platform 104 may convert the response data from POJO data as received by the legacy processing system 118 to XML data for compatibility with the remote device 102.

If the remote device 102 has been migrated, the data may be routed to a data transformation engine 122 of the gateway router system 100. In some embodiments, a password may be authenticated by a data authentication subsystem 120 prior to routing the data to the data transformation engine 122. For example, a password or other authentication credential of the source or remote device 102 may be required by the new processing system. The credential may be included along with or as part of the data. Upon successful authentication of the password or other user credential, the data may then be routed to the data transformation engine 122. The data transformation engine 122 may then map the data from the first data format (such as data leveraging specifications from a first API) that is compatible with the legacy processing system 118 to a second data format (such as data leveraging specifications associated with a different, second API) that is compatible with the new processing system 126. For example, the data transformation engine 122 may convert POJO data that is compatible with the first API to JavaScript Object Notation (JSON) that is compatible with the second API. The data mapping allows the various classes and objects of the first data format to be converted to the second data format by parsing out predefined portions of the data in the first format and replacing them with corresponding classes and objects of the second format, thus eliminating the need to recode the data systems of the remote devices 102 themselves. A single script of code may be written to the data transformation engine 122 that can perform this mapping for each data format/protocol used by the various remote devices 102. This confines any recoding effort to a finite number (based on the number of APIs and other data formats supported by the legacy processing system 118) of external mapping scripts coded only onto the data transformation engine 122. These mapping files may be exceptionally small, reducing the amount of coding required, as well as reducing the memory and processing requirements of the data transformation engine 122.

Data mapping may be done by running a script or other piece of computer code that transforms incoming data in a first data format to target data having a different data format. For example, the script may identify and parse out one or more attributes or values within the incoming data. These identified attributes may be matched to corresponding attributes in a second data format. The script may then convert or otherwise transform the incoming attributes into attributes matching the data format of the target data. The script may include a line of code that converts each incoming value or attribute to its respective target attribute, along with any associated variables. As just one example, a first data format may include a user's name as a single data field, such as CustomerName( ). A second data format may have two separate fields for this data, such as CustomerFirstName( ) and CustomerLastName( ). The script may identify the CustomerName( ) data field in the incoming data, along with a person's name associated with the data field, such as John Doe. The script may then transform the incoming attributes into target attributes in the second data format by generating CustomerFirstName(John) and CustomerLastName(Doe). Such mapping may be done using a simple script to transform each value to be processed by the new processing system 126. This effectively allows a short script to swap data attributes from the first data format of the incoming data to a second data format supported by the new processing system 126. An example of this mapping may be seen in Table 1 provided below.

TABLE 1

| Incoming Data Attribute | Target Data Attribute |
|---|---|
| (first data format) | (second data format) |
| engineDoc[0].orderFormDoc.transaction.currentTotals.totalsOrTaxList: | amount |
| {getTotalsOrTaxList( )\|type=List<com.firstdata.vpay.models. | |
| Totals>}[0].total.value | |
| engineDoc[0].orderFormDoc.consumer.billTo.location.address. | cardholderName |
| nameOrFirstNameOrLastName:{getNameOrFirstNameOrLastName( )\| | |
| type=List<com.firstdata.vpay.models.Name>}[0].value | |
| engineDoc[0].orderFormDoc.consumer.paymentMech.creditCard | ccNumber |
| OrCheckOrPayPal:{getCreditCardOrCheckOrPayPal( )\|type= | |
| List<com.firstdata.vpay.models.CreditCard>}[0].number.value | |
| engineDoc[0].orderFormDoc.consumer.billTo.location.address. | address.city |
| city.value | |
| engineDoc[0].orderFormDoc.consumer.billTo.location.address. | address.address1 |
| street1.value | |
| engineDoc[0].orderFormDoc.consumer.billTo.location.address. | address.state |
| stateProv.value | |
| engineDoc[0].orderFormDoc.consumer.billTo.location.address. | address.zip |
| postalCode.value | |
| engineDoc[0].orderFormDoc.transaction.currentTotals.totalsOrTaxList: | level3.altTaxAmount |
| {getTotalsOrTaxList( )\|type=List<com.firstdata.vpay.models. | |
| Totals>}[0].altTax.value | |
| engineDoc[0].orderFormDoc.transaction.currentTotals.totalsOrTaxList: | level3.discountAmount |
| {getTotalsOrTaxList( )\|type=List<com.firstdata.vpay.models. | |
| Totals>}[0].discAmt.value | |
| engineDoc[0].orderFormDoc.transaction.currentTotals.totalsOrTaxList: | level3.dutyAmount |
| {getTotalsOrTaxList( )\|type=List<com.firstdata.vpay.models. | |
| Totals>}[0].dutyTax.value | |
| engineDoc[0].orderFormDoc.transaction.currentTotals.totalsOrTaxList: | level3.freightAmount |
| {getTotalsOrTaxList( )\|type=List<com.firstdata.vpay.models. | |
| Totals>}[0].ship.value | |
| engineDoc[0].orderFormDoc.shippingInfo.shipFrom.location.address. | level3.shipFromZip |
| postalCode.value | |
| engineDoc[0].orderFormDoc.transaction.currentTotals.totalsOrTaxList: | level3.taxAmount |
| {getTotalsOrTaxList( )\|type=List<com.firstdata.vpay.models. | |
| Totals>}[0].stateTax.value | |
| engineDoc[0].orderFormDoc.consumer.shipTo.location.address. | level3.shipToAddress.city |
| city.value | |
| engineDoc[0].orderFormDoc.consumer.shipTo.location.address. | level3.shipToAddress.state |
| stateProv.value | |
| engineDoc[0].orderFormDoc.consumer.shipTo.location.address. | level3.shipToAddress.zip |
| postalCode.value | |
| engineDoc[0].orderFormDoc.consumer.email.value | level3.shipToAddress.email |
| engineDoc[0].orderFormDoc.consumer.shipTo.location.address. | level3.shipToAddress.name |
| nameOrFirstNameOrLastName:{getNameOrFirstNameOrLastName( )\| | |
| type=List<com.firstdata.vpay.models.Name>}[0].value | |
| engineDoc[0].orderFormDoc.consumer.shipTo.location.address. | level3.shipToAddress.address1 |
| street1.value | |

In Table 1, attributes of the incoming data from one of the remote devices 102 are mapped from a first data format shown in the left column to a second data format shown in the right column that is useable by the new processing system 126. The script running in the data transformation engine 122 recognizes each attribute of the first data format and maps it to a corresponding attribute of the second data format, thus converting the incoming data into data that is readable by the new processing system 126 while only needing to write a small mapping file for the data transformation engine 122. No additional coding is required at any other system, such as the remote device 102, legacy processing system 118, and/or new processing system 126.

Once the data is mapped to the second format, the transformed data may be sent to the new processing system 126 via a new processing system interface 124 of the gateway router system 100. The data may then be processed by the new processing system 126. In some embodiments, response data may be generated by or received at the new processing system 126. The response data is in the second data format supported by the new processing system 126. The response data may be communicated to the data transformation engine 122 via the new processing system interface 124. The data transformation engine 122 then maps the response data back to the first data format that is supported by the migrated remote device 102. This mapping may be similar to the mapping process described above, with the response data being in the second data format for conversion to the first data format. Such mapping may be done as shown in Table 2 provided below.

TABLE 2

| Incoming Data Attribute | Target Data Attribute |
|---|---|
| (second data format) | (first data format) |
| extras:{getExtras( )\|type=List<com.first | engineDoc[0].orderFormDoc.transaction.id.value |
| data.gatewayrouter.service.utils. | |
| IDGenerator>}[0].transactionID | |
| extras:{getExtras( )\|type=List<com.first | engineDoc[0].orderFormDoc.id.value |
| data.gatewayrouter.service.utils. | |
| IDGenerator>}[0].orderID | |
| extras:{getExtras( )\|type=List<com.first | engineDoc[0].orderFormDoc.groupId.value |
| data.gatewayrouter.service.utils. | |
| IDGenerator>}[0].groupID | |
| payeezyResponse.exactRespCode | engineDoc[0].orderFormDoc.transaction. |
| | cardProcResp.ccErrCode.value |
| payeezyResponse.amount | engineDoc[0].orderFormDoc.transaction.currentTotals. |
| | totalsOrTaxList:{getTotalsOrTaxList( )\|type= |
| | List<com.firstdata.vpay.models.Totals>}[0].total.value |
| payeezyResponse.authorizationNum | engineDoc[0].orderFormDoc.transaction.authCode.value |
| payeezyResponse.ccExpiry | engineDoc[0].orderFormDoc.consumer.paymentMech. |
| | creditCardOrCheckOrPayPal:{getCreditCardOrCheckOrPayPal( )\| |
| | type=List<com.firstdata.vpay.models.CreditCard>}[0]. |
| | expires.value |
| payeezyResponse.cvdPresenceInd | engineDoc[0].orderFormDoc.consumer.paymentMech. |
| | CreditCardOrCheckOrPayPal:{getCreditCardOrCheckOrPayPal( )\| |
| | type=List<com.firstdata.vpay.models.CreditCard>}[0]. |
| | cvv2Indicator.value |
| payeezyResponse.currencyCode | engineDoc[0].orderFormDoc.orderItemList.orderItem[0].total. |
| | currency |
| payeezyResponse.creditCardType | engineDoc[0].orderFormDoc.consumer.paymentMech. |
| | creditCardOrCheckOrPayPal:{getCreditCardOrCheckOrPayPal( )\| |
| | type=List<com.firstdata.vpay.models.CreditCard>}[0]. |
| | type.value |
| payeezyResponse.avs | engineDoc[0].orderFormDoc.transaction.cardProcResp. |
| | avsRespCode.value |
| payeezyResponse.address.city | engineDoc[0].orderFormDoc.consumer.billTo.location.address. |
| | city.value |
| payeezyResponse.address.address1 | engineDoc[0].orderFormDoc.consumer.billTo.location.address. |
| | street1.value |
| payeezyResponse.address.state | engineDoc[0].orderFormDoc.consumer.billTo.location.address. |
| | stateProv.value |
| payeezyResponse.address.zip | engineDoc[0].orderFormDoc.consumer.billTo.location.address. |
| | postalCode.value |
| payeezyResponse.level3.discountAmount | engineDoc[0].orderFormDoc.transaction.currentTotals. |
| | totalsOrTaxList:{getTotalsOrTaxList( )\|type=List<com. |
| | firstdata.vpay.models.Totals>}[0].discAmt.value |
| payeezyResponse.level3.dutyAmount | engineDoc[0].orderFormDoc.transaction.currentTotals. |
| | totalsOrTaxList:{getTotalsOrTaxList( )\|type=List<com. |
| | firstdata.vpay.models.Totals>}[0].dutyTax.value |
| payeezyResponse.level3.freightAmount | engineDoc[0].orderFormDoc.transaction.currentTotals. |
| | totalsOrTaxList:{getTotalsOrTaxList( )\|type=List<com. |
| | firstdata.vpay.models.Totals>}[0].ship.value |
| payeezyResponse.level3.shipFromZip | engineDoc[0].orderFormDoc.shippingInfo.shipFrom.location. |
| | address.postalCode.value |
| payeezyResponse.level3.taxAmount | engineDoc[0].orderFormDoc.transaction.currentTotals. |
| | totalsOrTaxList:{getTotalsOrTaxList( )\|type=List<com. |
| | firstdata.vpay.models.Totals>}[0].stateTax.value |
| payeezyResponse.level3.shipToAddress. | engineDoc[0].orderFormDoc.consumer.shipTo.location.address. |
| city | city.value |
| payeezyResponse.level3.shipToAddress. | engineDoc[0].orderFormDoc.consumer.shipTo.location.address. |
| state | stateProv.value |
| payeezyResponse.level3.shipToAddress. | engineDoc[0].orderFormDoc.consumer.shipTo.location.address. |
| zip | postalCode.value |
| payeezyResponse.level3.shipToAddress. | engineDoc[0].orderFormDoc.consumer.email.value |
| email | |
| payeezyResponse.level3.shipToAddress. | engineDoc[0].orderFormDoc.consumer.shipTo.location.address. |
| name | nameOrFirstNameOrLastName:{getNameOrFirstNameOrLastName( )\| |
| | type=List<com.firstdata.vpay.models.Name>}[0].value |
| payeezyResponse.level3.shipToAddress. | engineDoc[0].orderFormDoc.consumer.shipTo.location.address. |
| address1 | street1.value |

Table 2 depicts a mapping process for mapping response data in the second data format to the first data format. For example, the data transformation engine may map JSON data to POJO data. The script running in the data transformation engine 122 essentially operates in reverse as compared to the initial mapping process. Here, the script recognizes each attribute of the response data in the second data format and maps it to a corresponding attribute of the first data format, thus converting the response data into data that is readable by the remote device 102.

Once mapped, the response data may be sent to the router switch 110. The router switch 110 may then determine a destination of the response data. For example, the response data may be generated to include an identifier or other indicator associated with the incoming data. The response data may then be routed to the proper destination/remote device 102 by the router switch 110. In embodiments that utilize a integration network platform 104, the integration network platform 104 may convert or otherwise transform the response data to the proper format for the particular remote device 102. For example, the integration network platform 104 may convert POJO data into XML data for transmission to the remote device 102.

The remote device, 102 integration network platform 104, legacy processing system 118, new processing system 126, gateway router system 100, and/or components thereof may be connected via one or more wired or wireless communications networks. The network(s) may include a local area network (LAN) and/or other private or public wired and/or wireless networks. The networks may utilize one or more of Wi-Fi, ZigBee, Bluetooth™, Bluetooth™ Low Energy, a cellular communications protocol such as 3G, 4G, or LTE, and/or any other wireless communications protocol. It will be appreciated that one or more different network connections may be used in accordance with the invention, and that the use of a single network to enable communications is merely one example of such configurations. For example, each component may be communicatively coupled with other components using a separate network for one or more of the connections.

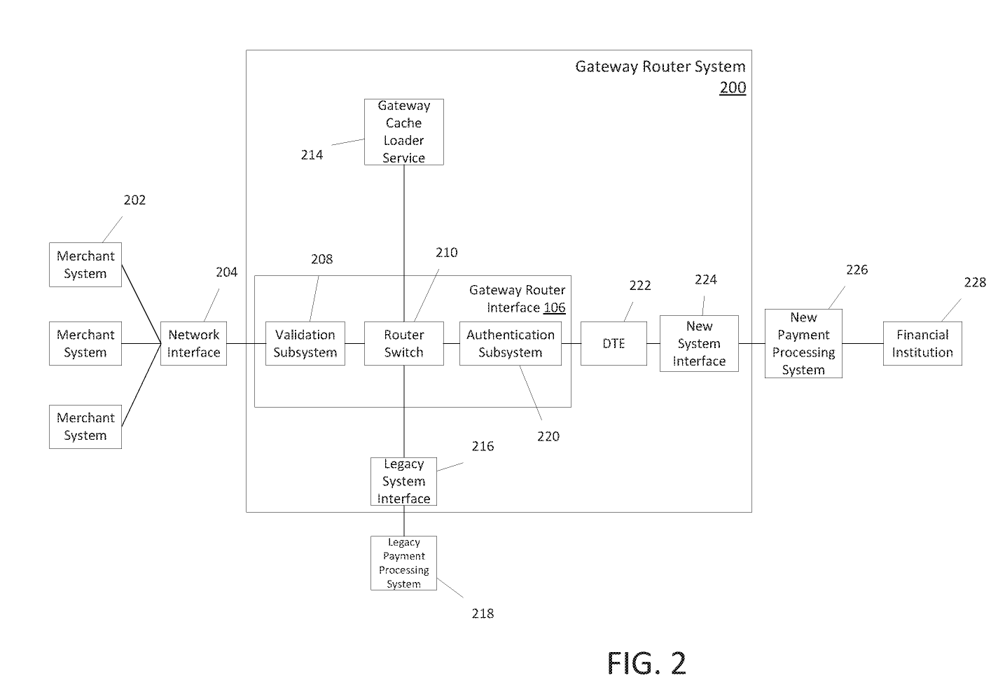

FIG. 2 depicts a system diagram of a gateway router system 200 that is used in a payment processing application. Gateway router system 200 may include similar features and components as gateway router system 100, and may function in similar manner to convert and route incoming and outgoing data. Here, gateway router system 100 is often used to route and transform incoming payment processing requests and outgoing payment processing responses (such as authentication confirmations and denials) when an payment processing entity is migrating merchants and other clients from a legacy payment processing system 218 that uses a first data format to a new payment processing system 226 that uses a different, second data format. Here, one or more merchant systems 202 may communicate with at least one integration network platform 204 that are communicatively coupled with the gateway router system 200 using one or more communications networks. The merchant systems 202 may be mobile devices, computer systems, servers, and/or other computing devices that are configured to interface with the gateway routing system 200 using an API. In some embodiments, each merchant system 202 may interface with the gateway router system 200 using its own unique API, while in other embodiments some or all of the merchant systems 202 may interface with the gateway router system using a single common API. In some embodiments, the merchant systems 202 may be in direct communication with the gateway router system 200 rather than using a integration network platform 204. Payment processing data, such as payment authorization requests and/or payment settlement requests, may be received by the gateway router system 200 from the merchant systems 202. The payment requests may be received in an initial data format or data protocol. In some embodiments, the payment requests may be converted or transformed into the initial data format or protocol by the integration network platform 204.

The gateway router system 200 may include a gateway router interface 106 that receives the data from the merchant systems 202 and/or the integration network platform 204. The gateway router interface 206 may include a validation subsystem 208 that is configured to validate the payment requests received from the merchant systems 202. Once validated, a router switch 210 may parse out a client or merchant identifier from the payment request and pass the client identifier to a gateway cache loader service 214 and/or other database. The identifier may be a merchant identification number (MID), a device or system identifier, and/or other unique identifier associated with a particular merchant system 202. For example, details related to the particular merchant system 202 may be fetched from the gateway cache loader service 214. The details may include information indicative of whether the particular merchant system 202 has been migrated to the new payment processing system 226, or if the merchant system is still using the legacy payment processing system 218. In some embodiments, such as if the gateway cache loader service 214 is empty and/or returns no details related to the particular merchant system 202 or embodiments not utilizing a gateway cache loader service 214, the details related to the particular source may be retrieved from a separate database (not shown). Once the details are retrieved, the router switch 210 may determine whether the particular merchant system 202 has been migrated based on the details. In other embodiments, the client or merchant identifier may be compared to a list of migrated merchants to determine whether migration of the particular merchant system 202 has taken place.

If the merchant system 202 has not been migrated, the payment request is communicated to the legacy payment processing system 218 via a legacy system interface 216 of the gateway router system 200. In some embodiments, the legacy system interface 216 may convert the payment request back into its original form. For instance, the POJO data generated by the integration network platform 204 may be converted back into XML data for use with the legacy processing system 218. The payment request may then be processed by the legacy payment processing system 218. In some embodiments, a payment response may be generated by or received at the legacy payment processing system 218 in response to processing the payment request. For example, the payment response may be an authorization confirmation or denial and/or a settlement funded by a bank or other financial institution. In other embodiments, the new payment processing system 226 may make funding determinations. The payment response may be communicated to the router switch 210 via the legacy system interface 216 in the form of response data. The router switch 210 may then determine a destination of the response data, such as by retrieving details associated with the merchant system 202 from which the payment request originated. The payment response may then be routed to the proper merchant system 202 by the router switch 210. In embodiments that utilize a integration network platform 204, the integration network platform 204 may convert or otherwise transform the response data to the proper format for the particular merchant system 202.

If the merchant system 202 has been migrated, the payment request may be routed to a data transformation engine 222 of the gateway router system 200. In some embodiments, a password or other authentication credential may be authenticated by a data authentication subsystem 220 prior to routing the payment request to the data transformation engine 222. Upon successful authentication of the password or other user credential, the payment request may then be routed to the data transformation engine 222. The data transformation engine 222 may then map the payment request from the first data format to a second data format that is compatible with the new payment processing system 226. This mapping may be done in a manner similar to that described above in relation to FIG. 1.

Once the payment request is mapped to the second format, the transformed payment request may be send to the new payment processing system 226 via a new payment processing system interface 224 of the gateway router system 200. The payment request may then be processed by the new payment processing system 226. For example, if the payment request was a request for payment authorization, the new payment processing system 226 may interface with a payment issuer, bank, and/or other financial institution 228 to authorize or deny the payment authorization request, which may include payment details such as a total transaction amount to be authorized. The new payment processing system 226 may then generate a payment response indicating that the request was authorized or denied. As another example, if the payment request is a request for settlement of funds, the new payment processing system 226 may interface with a bank or other financial institution 228 to transfer settlement funds from the financial institution 228 to the merchant system 202 or an account associated with the merchant system 202. The payment response is generated in the second data format supported by the new payment processing system 226 and may be communicated to the data transformation engine 222 via the new payment processing system interface 224. The payment response is then mapped back to the first data format by the data transformation engine 222. This mapping may be similar to the mapping processes described herein.

Once mapped, the payment response may be sent to the router switch 210. The payment response may then be routed to the proper merchant system 202 by the router switch 210. In embodiments that utilize a integration network platform 204, the integration network platform 204 may convert or otherwise transform the response data to the proper format for the particular merchant system 202.

It will be appreciated that the system diagrams described above with regard to FIGS. 1 and 2 are merely two embodiments of gateway router systems for transforming and routing data among multiple devices and processing systems. In other embodiments, functionality of some of the components may be merged or combined into a single system or subsystems. Some systems, subsystems, and/or other components may be omitted, and/or additional components and systems may be added to meet the needs of a particular application.

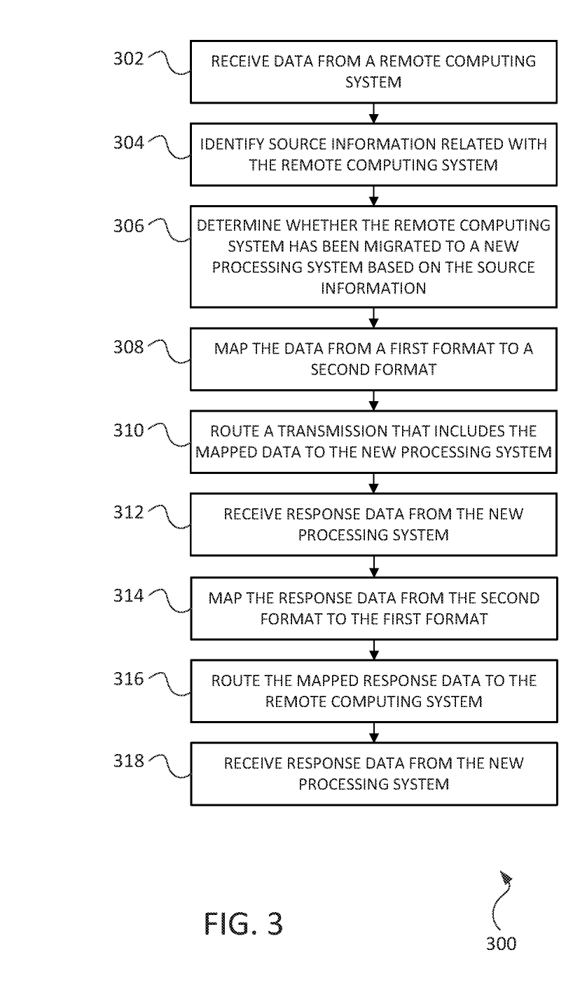

FIG. 3 is a flowchart of a process 300 for routing and transforming data according to one embodiment. Process 300 may be performed by a gateway router system, such as those described in relation to FIGS. 1 and 2. Process 300 may include receiving data from one of a plurality of remote computing systems at block 302. In some embodiments, the data may in a first data format associated with a legacy processing system. In some embodiments, the data may be received directly from one of the remote computing systems in the first format, while in other embodiments the incoming data may be received via an intermediate integration network platform in a different format. In some embodiments, the integration network platform may convert data from the different data format to the first data format that is compatible with the legacy processing system. For example, data from the remote computing system may be XML data, which may be converted to POJO data that is compatible with the gateway router system.

Once the data has been received, source information related to the one of the plurality of remote computing systems may be identified at block 302. This may include, for example, parsing out a client identifier from the data and using the client identifier to fetch details related to the source of the data. Such details may include information indicative of whether the particular source has been migrated to the new processing system or if the source is still being serviced by the legacy processing system. At block 306, a determination is made whether the particular remote computing system has been migrated to a new processing system based at least in part on the source information. In some embodiments, the details may explicitly indicate whether migration has occurred, while in other embodiments the details may include only an identifier of the data source. In such embodiments, the retrieved details may be used to determine whether the source has been migrated based on a comparison of the source identifier to a list of identifiers of migrated sources/remote devices to determine whether the particular source has been migrated to the new processing system.

If it is determined that the remote computing system has not yet been migrated, the data is communicated to a legacy processing system, oftentimes using a legacy system interface. In some embodiments, the legacy system interface may convert the data back into its original form. For instance, the POJO data generated by the integration network platform may be converted back into XML data for use with the legacy processing system. The data may then be processed by the legacy processing system. In some embodiments, response data may be generated by or received at the legacy processing system. In some embodiments, the response data may be in a format not compatible with the gateway router system. For example, the response data may be XML data. In such embodiments, an interface between the legacy processing system and the gateway router system may convert the XML response data into a usable format, such as POJO data. A destination of the response data is determined, such as by retrieving details associated with the source/remote device of the original data. For example, the response data may include an identifier or indication associating the response data with the original incoming data. The response data may then be routed to the proper remote computing system. In embodiments that utilize a integration network platform, the integration network platform may convert or otherwise transform the response data to the proper format for the particular remote computing system. For example, the response data may be converted from POJO data to XML data for compatibility with the remote computing system.

If the remote computing source has been migrated, the data is mapped to a second data format associated with the new processing system at block 308. For example, the data may be POJO data, while the second data format may be JSON data. In some embodiments, the mapping may be based at least in part on the first data protocol. For example, the first data format may be detected and a corresponding mapping file may be selected that is configured to map the first data format to the second data format. In some embodiments, the first data format may be determined based on the source information. For example, the source information may be used to lookup the data format used by the particular remote computing system from which the data originated. In other embodiments, the mapping may be based on a data format that is compatible with the gateway router system. For example, if a integration network platform has converted the incoming data, then the new converted format may be what is mapped to the second data format. The mapping file may be configured to identify the various objects, classes, and/or other attributes within the incoming data file and swap them with corresponding attributes of the second data format. In this manner, the incoming data may be converted to a format usable with the new processing system without the need to update the remote computing system or to recode any system other than within a data transformation engine of the gateway router system. In some embodiments, the incoming data includes a user credential associated with the one of the plurality of remote computing systems. This user credential may be used to authenticate the source of the incoming data prior to mapping the data.

At block 310, a transmission is routed to the new processing system. The transmission includes the mapped data in the second data format. The mapped data may then be processed by the new processing system. Oftentimes, a response is then received from the new processing system. This response may be mapped from the second data protocol to the first data protocol for transmission to the source of the original data. The mapped response may be routed to the proper remote computing systems based at least in part on the source information associated with the original data. For example, the response may include an identifier or other indication associated with the original data.

In applications where the gateway router system is used to handle payment processing, the incoming data may be a payment authorization or funding request. Once transmitted for processing by a legacy processing system or a new processing system (after mapping), the payment request may be processed by the respective processing system and/or a financial institution, such as a bank or other account host. The processing system handling the payment request may then receive from the financial institution and/or itself process and generate an authorization or funding response. This payment authorization response may be mapped to the format of the original payment request if needed, and then may be routed to a proper remote computing system, which may be a merchant system in this case.

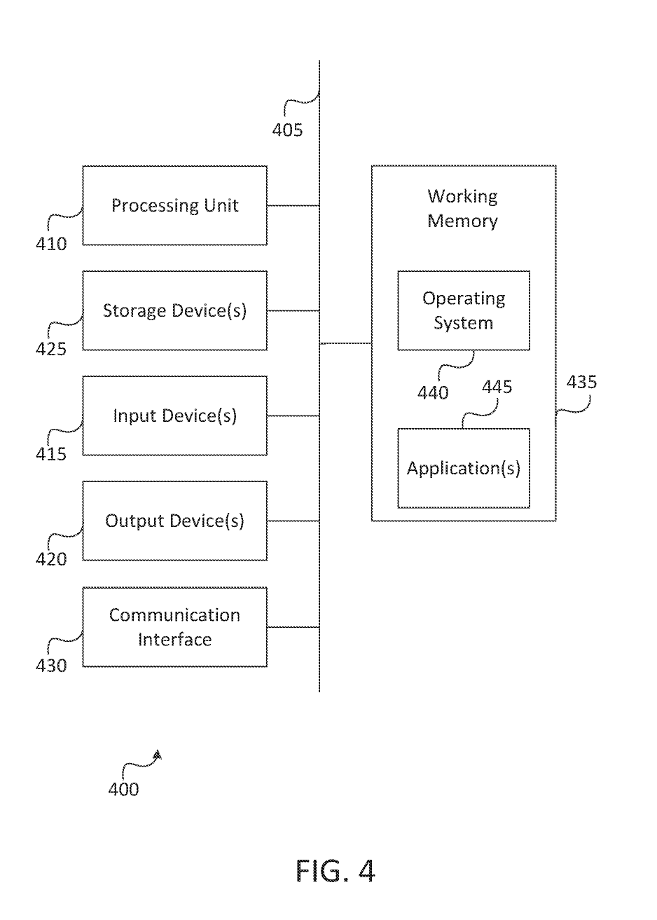

A computer system as illustrated in FIG. 4 may be incorporated as part of the previously described computerized devices. For example, computer system 400 can represent some of the components of remote devices 102, merchant systems 202, gateway router systems 100 and 200, legacy systems 118 and 218, new systems 126 and 226, and/or other computing devices as described herein. FIG. 4 provides a schematic illustration of one embodiment of a computer system 400 that can perform the methods provided by various other embodiments, as described herein, and/or can function as a server, mobile device, remote device, merchant system, gateway router system, processing system, and/or other computer system. FIG. 4 is meant only to provide a generalized illustration of various components, any or all of which may be utilized as appropriate. FIG. 4, therefore, broadly illustrates how individual system elements may be implemented in a relatively separated or relatively more integrated manner.

The computer system 400 is shown comprising hardware elements that can be electrically coupled via a bus 405 (or may otherwise be in communication, as appropriate). The hardware elements may include a processing unit 410, including without limitation one or more processors programmed to perform particular functions, such as one or more special-purpose processors (such as digital signal processing chips, graphics acceleration processors, and/or the like); one or more input devices 415, which can include without limitation a mouse, a keyboard, a touchscreen, receiver, a motion sensor, a camera, a smartcard reader, a contactless media reader, and/or the like; and one or more output devices 420, which can include without limitation a display device, a speaker, a printer, a writing module, and/or the like.

The computer system 400 may further include (and/or be in communication with) one or more non-transitory storage devices 425, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data stores, including without limitation, various file systems, ledger or database structures, and/or the like.

The computer system 400 might also include a communication interface 430, which can include without limitation a modem, a network card (wireless or wired), an infrared communication device, a wireless communication device and/or chipset (such as a Bluetooth™ device, an 502.11 device, a Wi-Fi device, a WiMax device, an NFC device, cellular communication facilities, etc.), and/or similar communication interfaces. The communication interface 430 may permit data to be exchanged with a network (such as the network described below, to name one example), other computer systems, and/or any other devices described herein. In many embodiments, the computer system 400 will further comprise a non-transitory working memory 435, which can include a RAM and/or ROM device, as described above.

The computer system 400 also can comprise software elements, shown as being currently located within the working memory 435, including an operating system 440, device drivers, executable libraries, and/or other code, such as one or more application programs 445, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a computer (or other device) to perform one or more operations in accordance with the described methods.

A set of these instructions and/or code might be stored on a computer-readable storage medium, such as the storage device(s) 425 described above. In some cases, the storage medium might be incorporated within a computer system, such as computer system 400. In other embodiments, the storage medium might be separate from a computer system (e.g., a removable medium, such as a compact disc), and/or provided in an installation package, such that the storage medium can be used to program, configure and/or adapt a computer for a specific purpose using the instructions/code stored thereon. These instructions might take the form of executable code, which is executable by the computer system 400 and/or might take the form of source and/or installable code, which, upon compilation and/or installation on the computer system 400 (e.g., using any of a variety of compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Moreover, hardware and/or software components that provide certain functionality can comprise a dedicated system having specialized components. For example, a provisioning system configured to provide some or all of the features described herein relating to the provisioning of rates can comprise hardware and/or software that is specialized (e.g., an application-specific integrated circuit (ASIC), a software method, etc.) to carry out a specific function. Further, connection to other computing devices such as network input/output devices may be employed.

Some embodiments may employ a computer system (such as the computer system 400) to perform methods in accordance with the disclosure. For example, some or all of the procedures of the described methods may be performed by the computer system 400 in response to processing unit 410 executing one or more sequences of one or more instructions (which might be incorporated into the operating system 440 and/or other code, such as an application program 445) contained in the working memory 435. Such instructions may be read into the working memory 435 from another computer-readable medium, such as one or more of the storage device(s) 425. Merely by way of example, execution of the sequences of instructions contained in the working memory 435 might cause the processing unit 410 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 400, various computer-readable media might be involved in providing instructions/code to processing unit 410 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 425. Volatile media include, without limitation, dynamic memory, such as the working memory 435. Transmission media include, without limitation, coaxial cables, copper wire and fiber optics, including the wires that comprise the bus 405, as well as the various components of the communication interface 430 (and/or the media by which the communication interface 430 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a magnetic medium, optical medium, or any other physical medium with patterns of holes, a RAM, a PROM, EPROM, a FLASH-EPROM, any other memory chip or cartridge, a carrier wave as described hereinafter, or any other medium from which a computer can read instructions and/or code.

The communication interface 430 (and/or components thereof) generally will receive the signals, and the bus 405 then might carry the signals (and/or the data, instructions, etc. carried by the signals) to the working memory 435, from which the processor(s) 405 retrieves and executes the instructions. The instructions received by the working memory 435 may optionally be stored on a non-transitory storage device 425 either before or after execution by the processing unit 410.

The methods, systems, and devices discussed above are examples. Some embodiments were described as processes depicted as flow diagrams or block diagrams. Although each may describe the operations as a sequential process, many of the operations can be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

It should be noted that the systems and devices discussed above are intended merely to be examples. It must be stressed that various embodiments may omit, substitute, or add various procedures or components as appropriate. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known structures and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A method for transforming and routing data, the method comprising:
receiving data from one of a plurality of remote computing systems, the data being in the form of a first data format associated with a legacy processing system;
identifying source information related to the one of the plurality of remote computing systems;
determining that the one of the plurality of remote computing systems has been migrated to a new processing system based at least in part on the source information;
mapping the data a second data format associated with the new processing system; and
routing a transmission to the new processing system, the transmission comprising the mapped data in the form of the second data format.

2. The method for transforming and routing data of claim 1, wherein:
the data further comprises a user credential associated with the one of the plurality of remote computing systems; and
the method further comprises verifying the user credential prior to mapping the data.

3. The method for transforming and routing data of claim 1, wherein:
the data further comprises an identifier associated with the one of the plurality of remote computing systems; and
identifying source information comprises passing the identifier to a source information system and receiving the source information in response to the passing the identifier.

4. The method for transforming and routing data of claim 1, further comprising:
determining the first data format based at least in part on the source information.

5. The method for transforming and routing data of claim 1, wherein:
the data comprises a payment authorization request; and
the method further comprises receiving an authorization response from the new processing system, the authorization response being in the second data format.

6. The method for transforming and routing data of claim 5, further comprising:
mapping the authorization response from the second data format to the first data format; and
routing the mapped authorization response to the one of the plurality of remote computing systems.

7. The method for transforming and routing data of claim 1, further comprising:
receiving a response from the new processing system;
mapping the response from the second data protocol to the first data protocol or another format; and
routing the mapped response to the one of a plurality of remote computing systems based at least in part on the source information.

8. A gateway router system for transforming and routing data, the system comprising:
a gateway router interface configured to:
receive data from one of a plurality of remote computing systems, the data being in the form of a first data format associated with a legacy processing system;
identify source information related to the one of the plurality of remote computing systems;
determine whether the one of the plurality of remote computing systems has been migrated to a new processing system based at least in part on the source information; and
route the data based on the determination;
a legacy system interface configured to:
receive the data from the gateway router interface when it is determined that the one of the plurality of remote computing systems has not been migrated to the new processing system; and
transmit the data to a legacy processing system;
a data transformation engine configured to:
receive the data from the gateway router interface when it is determined that the one of the plurality of remote computing systems has been migrated to the new processing system; and
map the data to a second data format associated with the new processing system;
a new processing system interface configured to:
receive the mapped data from the data transformation engine; and
route a transmission to the new processing system, the transmission comprising the mapped data in the form of the second data format.

9. The gateway router system for transforming and routing data of claim 8, wherein:
the first data format comprises extensible markup language (XML) or plain old Java object (POJO).

10. The gateway router system for transforming and routing data of claim 8, wherein:
the second data format comprises JavaScript Object Notation (JSON).

11. The gateway router system for transforming and routing data of claim 8, further comprising:
a integration network platform configured to convert the data from the first data format into a format compatible with the gateway router system.

12. The gateway router system for transforming and routing data of claim 11, wherein:
the legacy system interface is further configured to convert the data from the format compatible with the gateway router system to the first data format.

13. The gateway router system for transforming and routing data of claim 11, wherein:
the data comprises a payment authorization request; and
the new processing system interface is further configured to receive an authorization response from the new processing system, the authorization response being in the second data format.

14. The gateway router system for transforming and routing data of claim 13, wherein:
the data transformation engine is further configured to map the authorization response from the second data format to the first data format or a format compatible with the gateway router system; and
the gateway router system is further configured to route the mapped authorization response to the one of the plurality of remote computing systems.

15. A gateway router system for transforming and routing data, the system comprising:
at least one communications interface configured to communicate with one or more computing systems using at least one network;
a memory; and
at least one processing unit, wherein the processing unit is configured to:
receive, via the at least one communications interface, data from one of a plurality of remote computing systems, the data being in the form of a first data protocol associated with a legacy processing system;
identify source information related to the one of the plurality of remote computing systems;
determine whether the one of the plurality of remote computing systems has been migrated to a new processing system based at least in part on the source information;
route the data to a legacy processing system when it is determined that the one of the plurality of remote computing systems has not been migrated to the new processing system;
map the data to a second data protocol associated with the new processing system when it is determined that the one of the plurality of remote computing systems has been migrated to the new processing system; and
route a transmission to the new processing system, the transmission comprising the mapped data in the form of the second data protocol.

16. The gateway router system for transforming and routing data of claim 15, wherein:
the data comprises a payment authorization request; and
the processor is further configured to receive an authorization response from the new processing system, the authorization response being in the second data format.

17. The gateway router system for transforming and routing data of claim 16, wherein the processor is further configured to:
map the authorization response from the second data format to the first data format or a format compatible with the gateway router system; and
the gateway router system is further configured to route the mapped authorization response to the one of the plurality of remote computing systems.

18. The gateway router system for transforming and routing data of claim 15, wherein:
the data further comprises a user credential associated with the one of the plurality of remote computing systems; and
the processor is further configured to verify the user credential prior to mapping the data.

19. The gateway router system for transforming and routing data of claim 15, wherein:
the data further comprises an identifier associated with the one of the plurality of remote computing systems; and
identifying source information comprises passing the identifier to a source information system and receiving the source information in response to the passing the identifier.

20. The gateway router system for transforming and routing data of claim 15, wherein the processor is further configured to:
determine the first data format based at least in part on the source information.
